(19) United States
(12) Patent Application Publication
(10) Pub. No.: US 2015/0074531 A1
(43) Pub. Date: Mar. 12, 2015

(54) SYSTEMS AND METHODS OF LOCATION-BASED DIGITAL CONTENT AGGREGATION

(71) Applicant: WHAMstream, LLC, Auburn Hills, MI (US)

(72) Inventors: Michael Morris, Auburn Hills, MI (US); Anthony Montalvo, Lynwood, CA (US)

(21) Appl. No.: 14/484,898

(22) Filed: Sep. 12, 2014

Related U.S. Application Data
(60) Provisional application No. 61/877,081, filed on Sep. 12, 2013.

(51) Int. Cl. H04L 29/06; G06F 3/0482

(52) U.S. Cl. CPC H04L 65/60; G06F 3/0482
USPC 715/716

(57) ABSTRACT

The present invention comprises in some embodiments a system for providing digital entertainment content to patron devices located within a location-based business or other establishment comprising: a client server capable of transmitting a listing of available digital entertainment content to said patron devices; and a digital media aggregation server, wherein the digital aggregation media server maintains and provides the listing of available digital entertainment content to the client server. In some aspects, the present invention provides a method of providing aggregated digital entertainment content to patrons of a location-based business or other establishment comprising providing a listing of available digital entertainment content to a patron device; providing selected digital entertainment content to a patron device.

### CROSS REFERENCE TO RELATED APPLICATIONS

This application claims priority to U.S. Provisional Application No. 61/877,081, filed on Sep. 12, 2013.

### BACKGROUND OF THE INVENTION

Patrons of location-based businesses and other establishments such as health clubs, libraries, schools, hotels, coffee shops and the like often spend considerable time on the premises. Businesses commonly provide or allow these patrons access to entertainment content, often as an essential component of their business, adding ‘atmosphere’, or simply to keep patrons occupied while waiting for another service. For example, a doctor's office may provide magazines to patients waiting in a reception area; in addition, the office will often play music over a public address (PA) system. Coffee shops will often provide live or recorded music and a selection of newspapers and magazine for their patrons. Health clubs may provide a limited array of entertainment content for persons working out on exercise equipment: motivational music played over the PA system; one or more common televisions, often connected to a cumbersome audio input/output apparatus on the workout equipment itself; and/or a limited supply of magazine titles. In some situations, patrons may bring their own physical copies of entertainment content to peruse while on the premises. In any case, the range of entertainment content available to the patron is fairly limited. Opportunities exist to provide a more diverse and personalized array of entertainment to patrons, improving the patron experience while at the location-based business.

More and more frequently, entertainment content is perused or ‘consumed’ in digital form (i.e., “digital entertainment content”) on mobile devices such as smart phones, tablets, laptops, personal music players and the like. Practically, an increased range of entertainment content is available to a given user in a given location via digital sources on a mobile device, rather than on physical media such as paper books, CDs magazines and the like, because large amounts of digital content can be stored efficiently in bulk on the device and/or transmitted to the device from an outside network. Digital entertainment content can range from electronic books (e-books), downloaded music or video loaded on the mobile and/or fixed devices. Often, where wireless or ethernet local area network connections to the Internet are available, users may stream audio and video from free or subscription-based content streaming services such as, for example, Spotify™ or Netflix™, in which the digital content is not directly stored on a mobile device but is sequentially fed to a mobile device through a network connection.

Most users will use their own personal mobile device to peruse digital entertainment content. It is noted that in some cases, businesses and other establishments may lend such mobile devices to be used by patrons while on the premises, and/or provide fixed devices such as computer terminals (i.e., free computer terminals at a library, for instance). Such provision of mobile and other devices carries significant costs in time and money in buying and repairing devices, lending and returning devices, etc., and thus most business do not provide such devices or do so in a limited manner. Overall, most users only have a relatively limited amount of digital content and content streaming services stored on or available on their mobile device, a small subset of the available digital content and content streaming services found on the Internet and other networks.

Thus, patrons who would like to consume digital entertainment on the premises of these business and establishments are, in the majority of situations, limited to what they bring in with them on their digital devices. Thus, providing patrons of location-based businesses and other establishments with exposure to a more diverse and/or personalized array of entertainment content and/or content streaming services is greatly desired to improve patron experiences in businesses and other establishments, while also allowing patrons the ability to trial new services and content.

### SUMMARY OF THE INVENTION

In some embodiments of the invention, a system for providing digital entertainment content to patron devices located within a location-based business or other establishment comprises a client server capable of transmitting a listing of available digital entertainment content to said patron devices; and a digital media aggregation server, wherein the digital aggregation media server maintains and provides the listing of available digital entertainment content to the client server. In some embodiments, the client server and digital media aggregation server are located on the same physical device.

In other embodiments, the system further comprises one or more patron devices capable of selecting and playing digital entertainment content. In yet other embodiments, the client server transmits a listing of available digital entertainment content to said patron devices over a local area network. In other embodiments the local area network consists of a wireless signal, a wired signal or both.

In other embodiments, the digital entertainment content comprises streaming services. In other embodiments, the digital entertainment content is only usable on the patron device while the patron device is connected to the client server. In other embodiments, the digital entertainment content is only usable by members of a location-based business or other establishment.

In some aspects of the invention, a method of providing aggregated digital entertainment content to patrons of a location-based business or other establishment comprises providing a listing of available digital entertainment content to a patron device and providing selected digital entertainment content to a patron device.

In some aspects, the providing a listing of available digital entertainment content to said patron devices and the providing selected digital entertainment content to a patron device occurs via a local area network. In other aspects, the local area network consists of a wireless signal, a wired signal or both. In other aspects, the digital entertainment content comprises streaming services.

In some aspects, the digital entertainment content is only usable on the patron device while the patron device is connected to the client server. In yet other aspects, the digital entertainment content is only usable by members of a location-based business or other establishment.

### DESCRIPTION OF THE DRAWINGS

FIG. 1 is a schematic drawing of an example embodiment of the present invention;

FIG. 2 is a schematic drawing of an example embodiment of an aggregation server of the present invention;

FIG. 3 is a screenshot from a mobile device depicting an example method for acquisition of the aggregation application on a patron mobile device;

FIG. 4 is a screenshot from an example password input screen within the aggregation application;

FIG. 5A is a screenshot of an example digital entertainment content jukebox depicting available types of entertainment content and services;

FIG. 5B is a screenshot of the example digital entertainment content jukebox depicting the amount of available titles and/or copies of the entertainment content and services to a patron under a location-based businesses' current licensing regime for the provided content and services.

### DETAILED DESCRIPTION OF THE INVENTION

Before any embodiments or aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected” and “coupled” are inclusive of both wireless and wired (i.e., physical or mechanical) connections or couplings capable of transmitting data to and from computing devices.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Persons of skill in the art will realize that systems and methods of the present invention may be embodied in software and/or hardware in whole or in part on any of the devices presented herein, and are not limited to purely software embodiments.

### DEFINITIONS

In general, terms used in the specification, drawing and claims shall be given their commonly used definition in the relevant arts. Where in conflict, the definitions provided below and elsewhere in the specification control.

“Digital entertainment content” refers to any digital media and/or files such as digital copies of magazines, magazine articles, e-books, music and movie files, as well as digital entertainment content streaming services. “Entertainment content” is inclusive of any kind of content perusable by patrons, such as educational content, such as how-to manuals and videos. Digital entertainment content may be produced in-house by the business (such as workout guides for a health club, for example) as well as outside sources.

A “listing” of available digital entertainment content is a list of such content that is available to patron of a particular location-based business. “Available content” may be such content as is licensed to the business or to the owner of the digital media aggregation server for distribution to one or more businesses; further a particular piece of content may be “unavailable” if all other licensed copies of that content are in use by other patrons. The “listing” may be stored and communicated to patron devices either by a client server or by a digital media aggregation server. The listing may be organized in any particular way for display on a patron device, preferably in a way helpful to patrons to find desired and available content. For example, a listing may be organized alphabetically, or hierarchically, e.g., classified by type of content, such as books, TV shows, music, movies, etc., with content nested within these categories in a series of sub-menus and the like.

“Location” refers to the location of a business or other establishment, and is in many cases based in “brick-and-mortar” locations such as a storefront or office, but may extend beyond the confines of a physical location (such as the entire grounds of a business, i.e. a parking lot or other outdoor facilities). A location is not limited to those locations with a brick-and-mortar component, but includes temporary or physical structure-less locations such as outdoor festivals and the like. Thus, a “location” is essentially co-extensive with the range of a wireless signal and/or wired signal (such as a wired WAN, LAN and the like) that can communicate with patron devices. Further, a device “located within” a particular business or establishment is inclusive of a device located within range of a business's wireless signal or a terminal device connected to a certain geographically limited wired network, for example.

“Patron devices” includes mobile devices as well as fixed devices that may be owned or used by a patron or provided to patrons by the business or other establishment while on the premises of the business/establishment.

“Streaming” refers to any method of transmitting digital content from one device and or server to a device (such as a mobile device) capable of playback of that content where the content is readable or playable by the device prior to the entire file being transmitted to the device, reducing waiting times to access that content for users (such as patrons) of that device. (Often digital content such as movies and songs are quite large in size and take some time to load at current data transmission speeds.) In some embodiments, only a portion of the entire digital file or content is transmitted to the user at one time (i.e., only the parts corresponding to and immediately before/after the part that that the user is currently perusing [watching/listening to/reading etc.]), which may conserve space on the mobile device and transmission bandwidth. In some applications, digital content is only temporarily stored or cached on the mobile device and is afterwards erased or is otherwise unavailable to the user after the current perusal of the digital content.

“Streaming services” store or have access to remotely stored digital content such as movie or song libraries, etc., and make it available to users via data streaming. Examples of streaming services may include Spotify, Pandora, Netflix, Amazon Prime, etc, where content to be streamed may be selected by users, as well as programmed streaming services such as Internet radio streams, where a stream of preselected content is streamed to users. The systems and methods of the present invention may directly stream locally or remotely stored digital entertainment content to patrons or act as an aggregation portal to other streaming services.

“Signal” refers to transmission of data via a wireless (e.g., WiFi) or wired connection (e.g., Ethernet, DSL, cable and the like) from one device, which may be detected by another device capable of detecting that signal.

“Server” refers in general to any computing or data storage device capable of or actively providing data, programs or other services over a network to be used by other computing devices (e.g., mobile devices). As is known in the art, a computing device can behave as both a server and a computing device simultaneously (for example, a client server can be a server to one or more patron devices, and that client server can be served by digital media aggregation server). Included within the scope of this invention are situations in which the functions of a server (i.e., a digital media aggregation server, etc.) as defined below can be spread out of multiple devices. Further, multiple servers can be run out of the same physical device, such that, for example, the functionality of a digital media aggregation server and a client server can be combined in the same physical device.

The systems and methods of the present invention comprise a location-based digital entertainment content streaming and aggregation service for mobile and other fixed devices capable of displaying entertainment content for patrons (i.e., members, guests, and/or invitees) of businesses and other establishments. In some aspects and embodiments, the cost of the service is tied to or added to membership fee/tuition of businesses, i.e., establishments or businesses that want to offer data streaming of all digital entertainment content offered to their member/customers while the member/customers are on the premises of that business or establishment. In some aspects and embodiments, data on which digital entertainment content and/or services, and kinds of digital entertainment content and/or services has been perused by a patron can be recorded, stored and/or transmitted to digital content providers and businesses. In some aspects and embodiments, demographic and other identification data about a patron (“membership data”) as well as data on which digital entertainment content and/or services or kinds of digital entertainment content and/or services has been perused by the patron can be recorded, stored and/or transmitted to digital content providers and businesses.

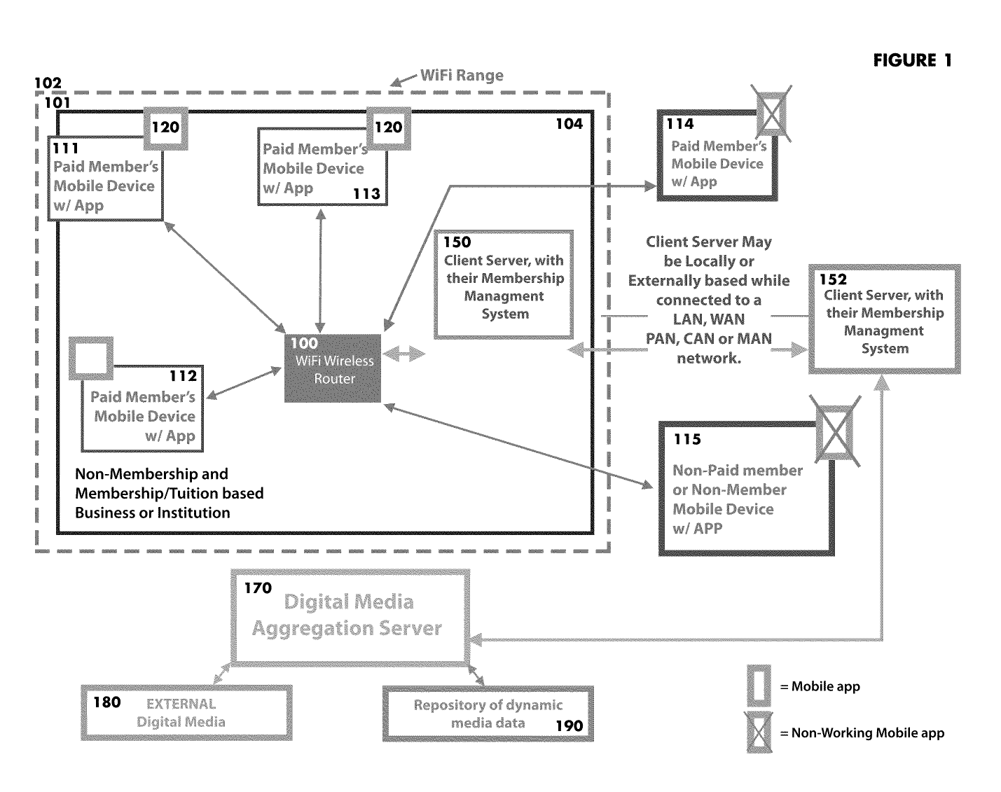

FIG. 1 depicts an illustrative embodiment of a system of the present invention. A wireless (“WiFi”) router 100 providing a wireless signal 101 with an approximate outer range 102 is located within a non-membership and membership/tuition based business or institution 104. In this embodiment, the range 102 of the wireless signal 101 is depicted as extending beyond the physical confines of the business 104. In other embodiments, the range of the wireless router may be coextensive with the physical location of the business or only extend to part of the business. In some embodiments, a location of a business or other establishment can be established by the location of the wireless router and range of the wireless signal, such that the invention may be used by businesses or other establishments outside or without a physical structure, such as an outdoor or temporary festival, etc.

The systems and methods of the present invention are not limited to the use of wireless signals, and may be used on or in tandem with fixed computing stations or terminals, such as computers at a library, for instance, connected to the systems of the present invention (described more fully below) by wired connections (such as Ethernet, DSL, cable, intranet connections, for example.) In some embodiments, fixed terminals may also be connected to the systems of the present invention with wireless signals. In some embodiments, mobile devices may be “docked” or connected via a suitable connector to a fixed computing station or terminal and/or be connected to a wired connection to the systems of the present invention. In some embodiments, systems and method of the present invention may include mobile device and/or fixed terminals connected to servers via wired or wireless connections.

The wireless and/or wired signal(s) may be used to transmit digital content and transmit and receive other information (as discussed in more detail below) between the wireless router 100 and one or more mobile devices (e.g., 111-115) located within range of the signal. For purposes of illustration, devices 111-113 belong to paid-up members of the non-membership and/or membership/tuition based business or institution (“club members”) 104 who have the aggregation application 120 described more fully below loaded or otherwise present on their device. Device 114 belongs to a paid-up members of the non-membership and/or membership/tuition based business or institution located outside the range of wireless signal 102, who thus in this example embodiment has a non-functional or partly functional (i.e., “disabled,” as indicated by a crossed-out box on FIG. 1) aggregation application on their device. Finally, device 115 belongs to a non-paid-up member or non-member of the non-membership and/or membership/tuition based business or institution who would have a non-functional or partly functional i.e., “disabled,” as indicated by a crossed-out box on FIG. 1) aggregation application on their device whether located outside or inside the range of signal 102.

Mobile devices include devices capable of communicating wirelessly and delivering audio and/or video content to patrons, such as smart phones, portable music and video players. In some embodiments, suitable mobile devices may be temporarily fixed to certain locations, such as walls, workout devices, etc. and physically connected to a communication network through Ethernet ports, or other means well known in the art. Communication with mobile devices is preferably through wireless local area networks (LAN) to allow patrons to move freely throughout the business premises while consuming entertainment contact. An example of a wireless LAN is provided in US Pub. App. No. 2004012030.

In some embodiments, signals may be sent to mobile devices through other wireless means other than via a router, such as via cellular networks and the like.

In order to receive digital content, patron devices 111-115 must be (a) connected to a wired or wireless LAN (i.e., 101), and (b) have the digital content aggregation application 120 loaded onto and enabled on the devices. A mobile device may be configured to come online, i.e., connect to the LAN, automatically when a patron is on the premises of the business or establishment via an automatic connection to a wireless LAN, or the patron may have to choose and enable wireless network 101, often by entering a password, etc. In this example embodiment, devices 114 and 115 are not able to receive digital content since they are outside the range of the wireless signal 102.

Once within the range of the wireless signal 102, patron mobile devices' access to the digital content system of the present invention may be controlled in several ways that may be used alone or in combination. Access may be limited to patron devices or devices of a limited subset of patrons (such as club members, see, e.g., 111-114). Access to the wireless signal and/or aggregation software may be limited to checked-in members, e.g., the process of checking in at the front desk allows access to the wireless network and/or aggregation software (see club members 111-113). Patron access information (such as membership information located in a membership management system) and digital content may be stored on on-site client servers 150, off-site client server 152, or aggregation server 170, or a combination thereof, for distribution to enabled on-location patron mobile devices 111-113.

Access information, in some embodiments, e.g., membership information, may be stored in onsite client server 150. In other embodiments, access information, e.g., membership information may be stored on an offsite client server 152. In some embodiments, businesses or other establishments may have multiple locations and wish to store access information in a central offsite location 152. In some embodiments, access information may be stored locally at a single location or at each location of a multiple-location business. In some embodiments, access information may be stored locally and/or offsite. Persons of skill in the art will recognize that multiple client servers may be easily linked to and communicate with each other and are equivalent to the single or simple hierarchical server arrangements described here for purposes of example.

Servers (such as client servers) may be connected to each other, e.g., via a LAN, wide area network (WAN; e.g., the Internet), personal area network (PAN), controller area network (CAN) or metropolitan area network (MAN).

Digital entertainment content may be directly stored and accessed from onsite client server 150. In other embodiments, digital entertainment content may be directly stored on an offsite client server 152. In some embodiments, businesses or other establishments may have multiple locations and wish to store digital entertainment content in a central offsite location 152. In some embodiments, digital entertainment content may be stored locally at a single location or at each location of a multiple-location business. In some embodiments, digital entertainment content may be stored locally and/or offsite. As noted above, persons of skill in the art will recognize that multiple client servers may be easily linked to and communicate with each other and are equivalent to the single or simple hierarchical server arrangements described here for purposes of example.

In some embodiments, entertainment content may be stored and/or transmitted through and or managed from an digital media aggregation server 170, where access to external digital content 180 (such as digital content stored on the Internet for example) as well as repositories of dynamic media data 190 are controlled. Repositories of dynamic media data 190 may be accessed to control and record number of plays of particular digital media files (songs, magazine articles and the like) for purposes of royalty collection, etc.

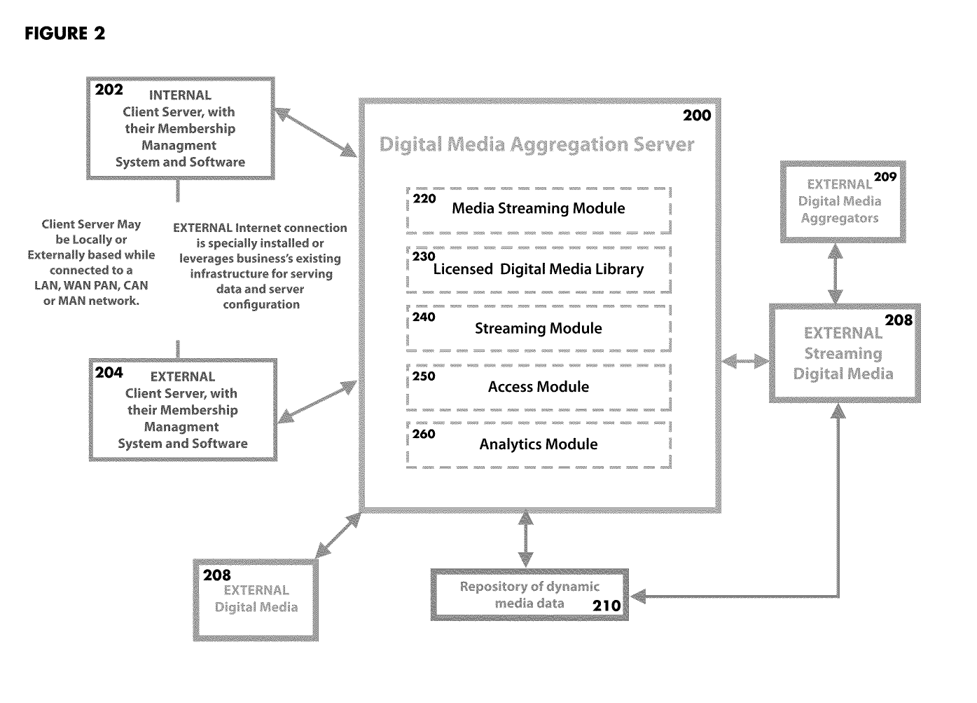

FIG. 2 depicts an example of a digital media aggregation server 200 in more detail. The digital media server 200 is capable of communicating with internal 202 and external 204 client servers wihich in this embodiment contain membership management systems and software, sources of external digital media 208 and external streaming digital media 209, as well as repositories of dynamic media data 210. One aggregation server may be responsible for one client server and/or business or may serve multiple client servers and/or businesses. The client server may be locally (internally) based 202 or externally based 204 while connected to a LAN, WAN, PAN, CAN or MAN network. An external internet connection is specially installed or leverages a business or other establishments' existing infrastructure for serving data and server configuration.

In some embodiments, the aggregation server 200 may have one, two, three, four, five, six or more functionalities. Persons of skill in the art will realize that the modular software or hardware organization specified herein is provided for purposes of example only and may be organized in any way that retains the overall one, two, three, four, five, six or more functionalities described below.

In some embodiments, the aggregation server 200 encompasses a media-streaming module 240. In this module, licensed media and streaming services are managed and streamed to client servers and ultimately to patron mobile and other devices. In some embodiments, mobile streaming applications may be incorporated into the mobile streaming module and the stream sent to one or more patron devices via client servers. In some embodiments, patron information and content information such as name of song, movie streamed, for instance, may be recorded and stored by the media streaming module.

Various licensing terms of the particular streaming service, if any, can be enabled and enforced by the streaming module 240. One or more subscriptions may be held or be located on the aggregation server, such that the streaming services are available to many client servers. Subscriptions may be business or location-based, such that services are only available to patrons of particular businesses or other establishments.

In some embodiments, a limited number of subscriptions of a particular streaming service may be available to patrons of a particular streaming service, such that a limited number of instances of that service may be available at the same time. In some embodiments, an unlimited number of subscriptions may be available to patrons, such that unlimited instances of a service may be in use at the same time. The module 240 may monitor the number of a streaming service in use by patrons and not allow the number of a streaming service in use to exceed the number of licenses available.

In some embodiments, licensed digital content, such as magazines, books, music, movies, etc. may be stored in a licensed digital media library 230 on the aggregation server 200. In some embodiments, licensed content may be stored remotely such as on a client server, or in another external location and accessed via a LAN or WAN, for example. Examples of externally stored digital content include digital media stored and accessed over the Internet, cloud storage, stored on other servers, etc. The module 230 may monitor the number of instances of particular digital media in use by patrons and not allow the number of the digital media in use to exceed the number of licenses available.

In some embodiments of the present system and method, content may be directly downloaded to onto a patron device. In most cases, ability of patrons to access the downloaded content will be ended once the patron logs out or exits the digital content aggregation application or the patron leaves the range of the wireless router. In other embodiments, digital content is streamed to the patron mobile device, that is partially loaded and playback begun while the rest of the digital content is being loaded. In most cases, ability of patrons to access the streamed content will be ended once the digital content aggregation application is exited by the patron or the patron leaves the range of the wireless router. Any number of streaming protocols known in the art may be used to stream content.

In some embodiments, a notification may be made to a patron that a desired piece of digital content may be unavailable due to all available copies of the content being in use. In some embodiments, a notification may be sent to a patron when unavailable digital content becomes available due to an in-use copy being checked-in by another user.

In some embodiments, access module 250 may access and/or store patron membership information from client servers. In some aspects and embodiments, patrons granted access by the access module are able to access some or all of the entertainment content located on or controlled by the content server. In some aspects and embodiments, patrons are able to view and select available content via the digital media aggregation application program that displays currently available entertainment content to the patron on their mobile device. In some embodiments, there may be different tiers of membership (e.g., VIP membership, basic membership, etc.) with different levels of access to digital content. Such access may be age based and incorporate other content restrictions. Access information, in some embodiments, e.g., membership information, may be stored in onsite client server. In other embodiments, access information, e.g., membership information may be stored on an offsite client server. In some embodiments, businesses or other establishments may have multiple locations and wish to store access information in a central offsite location. In some embodiments, access information may be stored locally at a single location or at each location of a multiple-location business. In some embodiments, access information may be stored locally and/or offsite.

In some aspects and embodiments, analytics module 260 may store demographic and other identification data about a patron (“membership data”) as well as data on which digital entertainment content and/or services or kinds of digital entertainment content and/or services has been perused by the patron. This data can be recorded, stored and/or transmitted to digital content providers and businesses for use in marketing, refining content to patrons and other uses known in the relevant arts.

A. Aggregation Application

1. Acquisition.

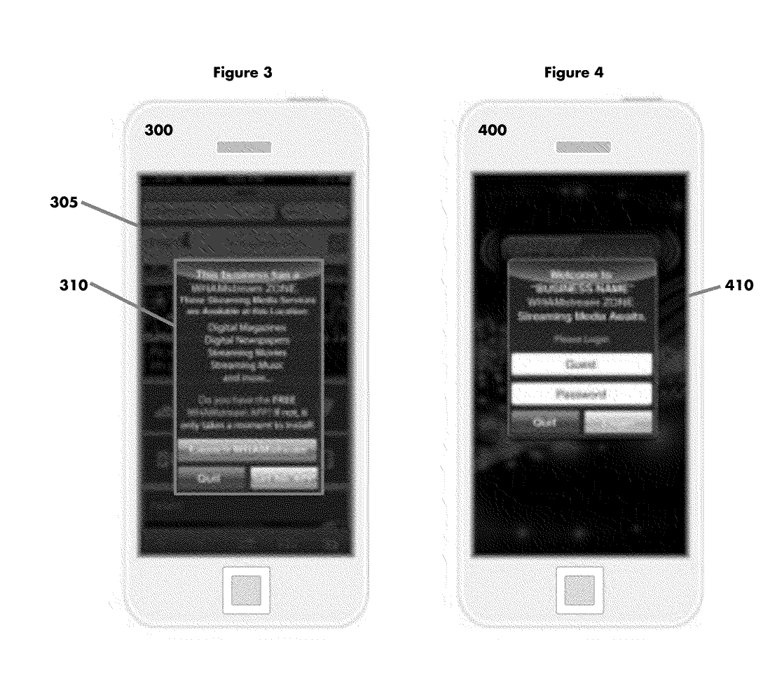

In one embodiment of systems of the present invention, one or more on-site client servers establish whether an aggregation application has been or needs to be installed on a mobile or other suitable device connected and in communication with the server via a wireless or other LAN. In one embodiment, shown in FIG. 3, an installation dialog box 310 is displayed by aggregation application 305 on the screen of mobile device 300 upon connection with a wireless router. In other embodiments, the option to download an aggregation application may appear as a link on a wireless network login webpage that appears after a user opens a web browser (often containing terms of usage or a password input prompt to fully access the wireless network), or in a popup window that automatically opens when the browser opens. In some embodiments, where the aggregation application is provided as part of a business-specific application, the aggregation application may be downloaded onto a mobile device as part of an application update and the like.

It is contemplated that in the case of fixed devices owned or provided by the business, these devices may be automatically loaded into the device via any of the above methods, or any other suitable method, such as CD, Internet download, and the like.

Once loaded onto the patron device, the aggregation application can be activated by the user when in range of the location-based business' wireless network. In some aspects, the aggregation application may be specific to each business or other establishment (i.e., one application for the library, one for member's workout club) or be able to work in multiple separate businesses or business locations (i.e., a business with multiple locations in a city or the country).

In one aspect, the aggregation application, when in contact with a business LAN may be customized for that particular club, with the business logo, messages for patrons and like. In another aspect, the aggregation application will be differently customized when in contact with the LAN of a different business.

2. Authentication.

In some situations an aggregation application may have been already loaded on a patron's mobile device when the patron enters the range of a wireless signal. In some embodiments, systems of the present invention may be installed in multiple locations/businesses, and the aggregation application may be used or usable at each location. However, the patron may not be allowed access to the system at that particular location/business. In such cases, the aggregation application 410 loaded on the mobile device 400 may provide a login prompt as shown in FIG. 4, and the patron required to enter a location-specific password in order to access the location-specific menu of available digital content. For example, a patron may have obtained the aggregation application from being a member at a public library; when entering an different establishment using the systems and methods of the present invention where the patron is not a member, the login screen will prevent unauthorized access. In some embodiments, this feature may be used alone or in tandem with other security features as described in more detail below.

3. Display Available Digital Content.

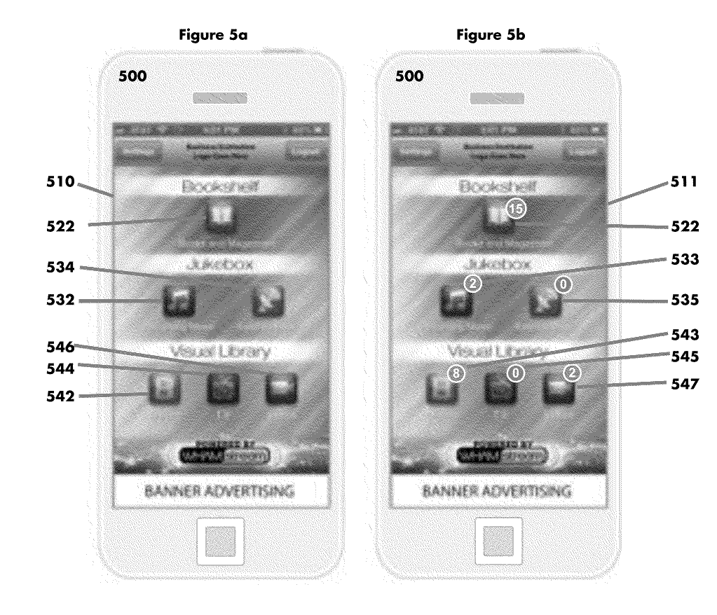

FIG. 5A depicts an example embodiment of a content selection menu display 510 on mobile phone 500 having an example embodiment of an aggregation application running on the device. Available content may include, for example, magazines and e-books 522, music 532, 534, and content streaming services 542, 544, 546. In many cases, licensing terms may apply to such digital content, such that a business or other establishment may have only a limited number of copies available of particular digital entertainment content and/or streaming services.

FIG. 5B shows an example content selection menu display 511 of an example embodiment of an aggregation application where systems and methods of the present invention may keep track of available copies of digital content (e.g, magazines and e-books 522). For instance, the display may show available copies of digital content in circles 533, 535, 543, 545, 547 of digital media content. For example, as seen in 535 and 545, the aggregation application shows that no copies are available of these particular streaming services. In some embodiments, the aggregation application alerts a patron when a copy of a particular piece of digital entertainment content or content streaming service becomes available. In other embodiments, a patron is only alerted when a copy of a particular piece of digital entertainment content previously requested by the patron becomes available.

4. Display of Digital Entertainment Content.

In some embodiments and aspects of the present invention, digital entertainment content may be displayed via one or more viewer applications incorporated into the aggregation application. Such applications may consist of an e-book reader, a music player, a movie viewer, etc. Supported file types may include, for example, .wav, mp3, mp4 etc. (for music), .pdf and .txt files (for magazines and e-books), .mov files for movies and others. In some embodiments, one or more of the viewers may stream the digital entertainment content.

In some embodiments and aspects, selection of particular digital entertainment content may prompt a separate viewer (for instance a default viewer preloaded onto the patron device for use with a particular type of digital media file) to play the digital media content. In some embodiments, an application customized to display a particular piece of digital entertainment content (an application customized to display a particular magazine, for instance) may be downloaded onto the patron mobile device and be used by the patron to peruse that digital entertainment content.

In some embodiments and aspects, patrons may have access to and select digital streaming services. Such digital streaming services may be streamed through a viewer application incorporated into the aggregation application, a separate default viewer, or an application specific to that streaming service that is downloaded onto the patron device.

B. Security of Digital Content on Patron Devices

In aspects and embodiments of the present invention, digital entertainment content is stored or cached temporarily on a patron device and is erased upon (1) a patron accessing another particular digital media file, (2) upon exit from the aggregation application and/or (3) leaving the location of the business or other establishment. In some embodiments, an application specific to the digital content or streaming service is loaded onto the mobile device. In these embodiments, the application specific to the digital content or streaming service may be erased upon exit from the aggregation application and/or leaving the location of the business or other establishment. In other embodiments, the application specific to the digital content or streaming service may be made be left on the patron device but made inactive upon exit from the aggregation application and/or leaving the location of the business or other establishment. The inactive application may be rendered active upon login to the aggregation application and/or return to the business location.

In some embodiments, the streaming data may be encrypted to prevent unauthorized acquisition of digital entertainment content. Such data may be encrypted during transmission and/or while cached on a patron device.

In some embodiments, security may be at least a dual-step process involving authentication on the client server at each location. In some embodiments, the aggregation server may authenticate patron devices; in some embodiments the client server and aggregation server may authenticate patron devices. Initial authentication may involve recording a patron device MAC address in order to authenticate the device itself, preventing patrons from registering multiple devices under one account unless authorized.

After device authentication, the client server and/or aggregation server checks (at administrator-configurable intervals, e.g., every 1, 2, 3, 4, 5 minutes, 10 minutes, 20 minutes, etc.) to make sure that the patron device is authorized to use the service. In the event of a lapsed/non-existent account the patron may be prompted to renew/create their account.

Additional verification and authentication steps may also be taken. Verification of the WIFI network that the patron device is using to connect to the server(s) will assist in verifying that the patron is not attempting to use the service outside of the business or other establishment.

In order to prevent forging of WIFI network names (SSIDs) the system may also verify that the user is on the proper IP range as defined by the administrators. Other security processes known in the art may be added to these protocols.

Aggregation Application Logout.

As noted above, in some embodiments, digital media content, viewing applications and/or streaming applications are rendered inactive or erased upon exit from the aggregation application and/or leaving the location of the business or other establishment. In some embodiments, a patron initiating an exit from the aggregation application will prompt the aggregation application to erase and/or render inactive digital media content, viewing applications and/or streaming applications. In some embodiments, a patron mobile device losing contact with a signal from a wireless router and/or wired signal (such as is the case when a patron mobile device is removed from a fixed docking station) for a specific period of time (e.g., 10 seconds, 1 minute, 2 minutes, 10 minutes, etc.) will cause the aggregation application to erase and/or render inactive digital media content, viewing applications and/or streaming applications.

C. Communication with Servers

In some aspects and embodiments, client servers are connected to a LAN capable of communicating digital entertainment content and other information to one or more patron devices located onsite. The source and location of the one or more client servers may vary. In some embodiments, the client server but may be local or located off-site via a remote server. If the server containing the client server application is located offsite, a local server may act as a proxy server, connected to the client server by an Internet connection, such as T1-T3 Internet connection. The proxy server then redistributes the streams over a LAN to individual patron devices. One or more proxy servers may be connected to one client server.

The client server and/or proxy server may be UNIX-based in some embodiments. In some embodiments, the digital entertainment content will be provided to member users via a predefined port (e.g., 9426) that will also allow the mobile user to switch their stream. Content and other data shutting between servers and users may use encryption, such as SSL Encryption, or other security protocols. Account verification (for proxy servers or user devices) may be made, for instance, via MAC address (See, e.g., U.S. Pat. No. 7,386,876).

D. Patron Access

In some aspects, member data, such as demographic data, e-mail data, may be communicated to content providers or streaming services when a member accessed their content or streamlining service.

In some aspects, the aggregation application can store guest or member information on the mobile device and communicate it via the club LAN to the client server, so that content stored by the client server or accessed via the client server then becomes available to the patron device.

In some aspects, the aggregation server can be connected to the a “check-in” process, such that upon member or guest check-in, i.e., check-in at the front desk of a business (e.g. a hotel or health club), digital entertainment content stored on or available via the client server may be available to the mobile device(s) of the member. In other aspects, a member may enter a password or other such security device (such as, but not limited to, voice recognition, thumbprints, and the like), which is recognized as associated with the member by the aggregation application on the client server.

In some aspects, access to the client server is limited to locations served by the business' wireless or wired network, thus, when a member leaves the club, access to entertainment content is terminated. In other aspects, access in terminated via a “check-out” procedure when a member leaves or otherwise checks out of the club, i.e., checks out at the front desk.

As noted above, not all embodiments of system and methods of the present invention require an onsite or offsite client server. In such cases, a centralized aggregation server could handle both user authentication and delegation of digital entertainment content from various sources. In cases where an onsite and/or offsite client server is present, the aggregation server may act as a client authentication system. Client authentication may for example, but not limited to, include client servers “checking in” with the aggregation server to ensure the location is authorized to (re)distribute licensed digital entertainment content sources. In the event of client server's authentication lapsing, said client server will no longer function to distribute content.

1. A system for providing digital entertainment content to patron devices located within a location-based business or other establishment comprising: a client server capable of transmitting a listing of available digital entertainment content to said patron devices;
and a digital media aggregation server, wherein the digital aggregation media server maintains and provides the listing of available digital entertainment content to the client server.

2. The system of claim 1, further comprising one or more patron devices capable of selecting and playing digital entertainment content.

3. The system of claim 2, wherein the client server transmits a listing of available digital entertainment content to said patron devices over a local area network.

4. The system of claim 1, wherein the local area network consists of a wireless signal, a wired signal or both.

5. The system of claim 4, wherein the digital entertainment content comprises streaming services.

6. The system of claim 5 wherein the digital entertainment content is only usable on the patron device while the patron device is connected to the client server.

7. The system of claim 6 wherein the digital entertainment content is only usable by members of a location-based business or other establishment.

8. The system of claim 1, wherein the client server and digital media aggregation server are located on the same physical device.

9. A method of providing aggregated digital entertainment content to patrons of a location-based business or other establishment comprising
providing a listing of available digital entertainment content to a patron device;
providing selected digital entertainment content to a patron device.

10. The method of claim 9, wherein the providing a listing of available digital entertainment content to said patron devices and the providing selected digital entertainment content to a patron device occurs via a local area network.

11. The method of claim 10, wherein the local area network consists of a wireless signal, a wired signal or both.

12. The method of claim 9, wherein the digital entertainment content comprises streaming services.

13. The method of claim 9, wherein the digital entertainment content is only usable on the patron device while the patron device is connected to the client server.

14. The method of claim 9 wherein the digital entertainment content is only usable by members of a location-based business or other establishment.
